(19) United States
(12) Patent Application Publication
(10) Pub. No.: US 2017/0124500 A1
(43) Pub. Date: May 4, 2017

(54) NETWORK INTERACTIVE PLATFORM AND METHOD FOR USING THE SAME

(71) Applicant: Ping SHEN, Beijing (CN)

(72) Inventor: PING SHEN, Beijing (CN)

(21) Appl. No.: 15/314,065

(22) PCT Filed: May 26, 2015
(86) PCT No.: PCT/CN2015/000360

§ 371 Date: Nov. 26, 2016

(30) Foreign Application Priority Data
May 26, 2014 (CN) 201410223646.6

(51) Int. Cl. G06Q 10/06; G06Q 40/04; G06Q 50/18; G06Q 40/06

(52) U.S. Cl. CPC G06Q 10/06313; G06Q 40/06; G06Q 40/04; G06Q 50/18

(57) ABSTRACT

This invention discloses a network interactive platform of the film and television industry internet and a method for using the same. Through the network interactive platform, it sets up a resource configuration module, an analysis application module, a deal right protection module, a business service module, a project management module, an investment and financing module, a database module and a derivative module to realize the bidirectional optimal configuration of film and television resources to give feasible analysis and results at the same time of analyzing data, suppling online transaction and evidence-obtaining and rights protection, suppling services related to laws and finance in the establishment, operation and termination of business institution, conducting investment and financing management so as to realize cooperation, development and transaction of film and television derivatives.

### BACKGROUND

1. Technical Field

This invention refers to the field of film and television and is used by conducting the bidirectional optimal configuration of film and television resources to give feasible analysis and results at the same time of analyzing data, supplying online transaction and evidence-obtaining and rights protection, providing services related to laws and finance in the establishment, operation and termination of business institution, and implementing investment and financing management so as to realize cooperation, development and transaction of film and television derivatives.

2. Description of Related Art

The current situation of film and television websites that comes to the market is as follows.

First of all, the movie websites mainly supplies the supply and demand information, learning information of film production, or video play and promotion service. These networks don't provide the mutual election service for producers, casts and relevant resources, making it difficult for the film production to find the best cast who does not have the fixed-term contract relationship to the working company. If film companies sign long-term contracts with casts who may not always be suitable for the film cultural products produced by the company, it would cause the contracts of casts to be in vain. As well as film materials to be wasted. Above all, the existing film websites can't supply a bidirectional optimal configuration of film resources.

Secondly, in film analysis, websites such as Entgroup Consulting that come to the market can recommend casts according to the nature of film culture and film-shooting requirements, but they can't supply the running schedule of the cast that is recommended, preventing the analysis results from being applied.

Thirdly, in trading right protection, the current websites don't supply online trading services such as user evaluation, online trading and evidence-obtaining and rights protection, etc., making it difficult to make decisions in advance because of the failure to understand the credit standing and working ability of the opposite. The contract cannot be signed in the process of the services, and it is difficult to compensate through legal remedy.

Fourthly, there aren't comprehensive business service platforms providing the business service to film and television industry, so small-scale companies and enterprises can't be instructed conveniently and effectively in preparing related procedures at the beginning of establishment or during business communication, and related evidence can't be saved timely and effectively. When having trade disputes, the party having no valid evidence can't be subsidized fairly. In routine business, finance and taxation can't be guided normally as clearing documents have to be provided repeatedly when terminating the business operation, which is not helpful to decline the clearing cost. Generally speaking, start-ups will encounter many business risks and higher operation cost if they are not well-organized.

Fifthly, in investment and financing of film and television, Yulebao, the crowdsourced film investment fund launched by China's largest e-commerce company—Alibaba is one of the investment websites of film and television industry. But Yulebao just connects investors with investment fields and is a third party crowd-funding tool, investors can't learn about the implementation details of the film project, such as shooting progress, issue time, etc., so they can't manage their investment funds effectively.

Finally, in the development of film and television derivatives, there are no specific network interactive platforms for the derivatives with the same type in terms of different films, so it has to set up sales channels respectively for each movie, causing wasted resources.

Above all, the existing film websites have the following problems. First of all, they can't achieve film collection and individuals to achieve the cooperation and complete online trading effectively. Secondly, there are no network trading services such as online trading and evaluation systems provided to ensure trades to be made timely, so it is difficult to learn conditions of the cooperative party such as credibility, work ability, etc., and it is difficult to make decisions in advance and ask for legal remedy. Thirdly, decision-making consulting and practical application have faults, so user's actual requirements cannot be met. Fourthly, it can't learn about and manage the project conditions of film investment and financing timely. Finally, there is no effective, convenient and categorized development, and also there is no sale channel for the film and television derivatives.

### SUMMARY

The present invention provides a network interactive platform adapted to industrial internetworking of film and television and a method for using the same.

The network interactive platform is supplied according to one aspect of the invention which includes a resource configuration module, an analysis application module, a deal right protection module, a business service module, a project management module, an investment and financing module, a database module and a derivative module.

The resource configuration module is used in a mutual election among investor and producer, producer and cast and relevant materials, and gives out allocation results. It is also used in the cooperative development of film and television derivatives.

The analysis application module is used to conduct data analysis and give out application projects according to the results of the data analysis and user requirement.

If users ensure to conduct trading according to the allocation results and application programs, the deal right protection module gives out format contracts according to the trading type, and saves trading data to the database module automatically. If users ask for a rights protection request, an evidence service is provided through the saved trading data, and a rights protection service is provided according to a result of the obtained evidence.

If users ensure to conduct trading according to the allocation results and the application programs, the deal right protection module gives out the format contracts according to the trading type, and saves the trading data to the database module automatically. If users ask for a rights protection request, the evidence service is provided through the saved trading data, and a rights protection service is provided according to the result of the obtained evidence.

The business service module includes a setting up service module, an operation service module, a terminating business operation service module, a legal service module, a financial service module, and a taxation service module.

The project management module is used to provide project progressive conditions, such as project progress, funds expenditure, etc., wherein the project management process includes the whole process of film and television preparation, production, issuing, and showing, and a combination thereof.

The investment and financing module is used to manage investment funds according to the progressive conditions of the project, and it is also used to conduct project financing.

The database module is used to save user information, trading information, service information, project progressive information, etc.

The derivative module conducts cooperation and development of the film and television derivatives.

Optimized trading data includes: user information, user exchange information, information of trading forming time, contracts, etc.

Optimized users include individual user, group user and project user. Individual users refer to users registered with the name of natural person, group users refer to users that are registered with the name of legal person or other organizations, and project users refer to users that are registered with the name of project.

Optimized resource configuration module includes: an exhibition module and a matching module, wherein the exhibition module is used to exhibit the user information, and the user information includes static information and dynamic information; the matching module is used in investor and producer, and a mutual election between producer and cast. The matching is conducted according to the usser requirement.

Optimized trading and rights protection module is used to supply customized contracts according to the requirement of both the parties of the trading.

Optimized setting service module in the business service module is used to supply service for the behavior of users to set up a company, an enterprise and other organizations; the business service module is used to supply service for the business behavior of users; a terminating business operation service module is used to supply service to the behavior of users to terminate business; a legal service module is used to supply legal service for the behavior of a setting, operation and termination of users; a financial service module is used to supply financial service for the behavior of a setting, operation and termination of users; and a taxation service module is used to supply taxation service for the behavior of a setting, operation and termination of users.

Each module in optimized business service module includes a format service module and a personalized service module.

Optimized legal service module supplies legal service according to the trading data that is obtained from a database.

A method using the network interactive platform is supplied according to the other aspect of the invention.

The method using the network interactive platform includes the following steps of which the sequence can be made according to actual requirements, wherein the network interactive platform includes a resource configuration module, an analysis application module, a deal right protection module, a business service module, a project management module, an investment and financing module, a database module, and a derivative module. The steps includes:

Step One: conducting a mutual election among investor and producer, producer and cast, and relevant materials, giving out allocation results, and implementing cooperative development of film and television derivatives;

Step Two: conducting a data analysis of film and television, and giving out application programs according to the result of the data analysis and user requirement;

Step three: if users ensure to conduct trading according to the allocation results and application programs, the deal right protection module giving out format contracts according to the trading type, and saving trading data to a database module automatically; if users ask for a rights protection request, an evidence service being provided through the saved trading data, and a rights protection service being provided according to the result of the obtained evidence;

Step four: implementing operations such as an establishment of a. business service, an operation of business service, a terminating business opera on service, a legal assistance service, a financial service and taxation service;

Step five: conducting a project tracing and supplying project progressive conditions automatically; such as a project progress and a capital expenditure;

Step six: conducting management to invested funds according to the project progressive conditions, and conducting project financing;

Step seven: saving user information, trading information, service information and project progressive information through database; and

Step eight: conducting a cooperation and development of film and television derivatives.

Using the network interactive platform and the method for using the same of the present invention can realize the bidirectional optimal configuration of film and television resources to give feasible analysis and results at the same time of analyzing data, supplying online transaction and evidence-obtaining and rights protection, providing services related to laws and finance in the establishment, operation and termination of business institution, and implementing investment and financing management so as to realize cooperation, development and transaction of film and television derivatives.

In order to further appreciate the characteristics and technical contents of the instant invention, references are hereunder made to the detailed descriptions and appended drawings in connection with the instant invention. However, the appended drawings are merely shown for exemplary purposes, rather than being used to restrict the scope of the instant invention.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 shows the network interactive platform supplied by the invention; and

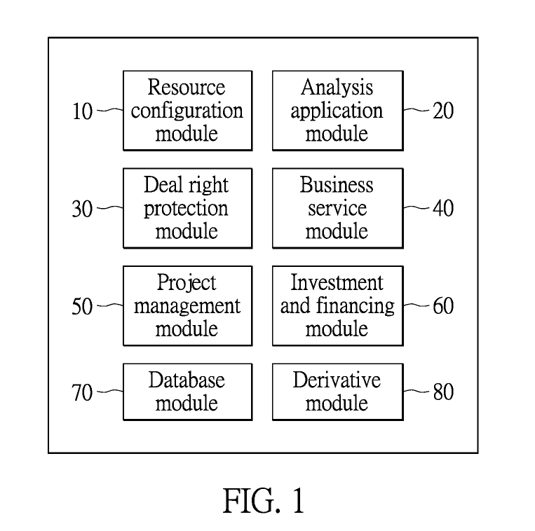

FIG. 2 shows the business service module supplied by the invention.

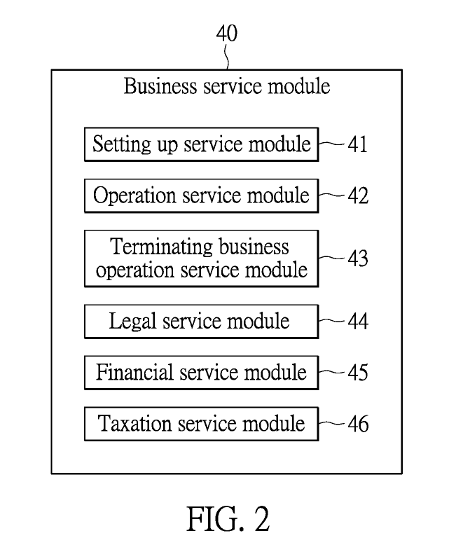

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

Case I

A network interactive platform includes a resource configuration module 10, an analysis application module 20, a deal right protection module 30, a business service module 40, a project management module 50, an investment and financing module 60, a database module 70, and a derivative module 80.

The resource configuration module 10 is used in a mutual election among investor and producer, producer and cast, and relevant materials, and gives out allocation results. It is also used in a cooperative development film and television derivatives.

The analysis application module 20 is used to conduct a data analysis and give out application projects according to the results of the data analysis and user requirement.

If users ensure to conduct trading according to the allocation results and application programs, the deal right protection module 30 gives out format contracts according to the trading type, and saves trading data to a database module automatically. If users ask for a rights protection request, an evidence service is provided through the saved trading data, and a rights protection service is provided according to the result of the obtained evidence.

The business service module 40 includes a setting up service module 41, an operation service module 42, a terminating business operation service module 43, a legal service module 44, a financial service module 45, and a taxation service module 46.

The project management module 50 is used to provide project progressive conditions, such as a project progress, a funds expenditure, etc., wherein the project management process includes the whole process of film and television preparation, production, issuing, and showing, and a combination thereof.

The investment and financing module 60 is used to manage investment funds according to the progressive conditions of the project, and it is also used to conduct project financing.

The database module 70 is used to save users information, trading information, service information, and project progressive information.

The derivative module 80 conducts a cooperation and development of film and television derivatives.

The above network interactive platform is used to conduct the bidirectional optimal configuration of film and television resources to give feasible analysis and results at the same time of analyzing data, to supply online transaction and evidence-obtaining and rights protection, to provide services related to laws and finance in the establishment, operation, and termination of business institution, and to implement investment and financing management so as to realize cooperation, development and transaction of film and television derivatives.

Case II

The following procedures are conducted successively when using the network interactive platform.

1. Users log in the network interactive platform, wherein users can log in as a guest or fill in information to become a registered user. In addition to the special function of registered users, guests can use other functions in the platform, and then users can exhibit contents such as works in the platform, and fulfill required projects. It can supply network announcement platform for users through this procedure, and display information, works, and requirements of users.

2. Users propose formatting or personalized matching requirements to networking interactive platform, and obtain the results of resources allocation from the networking interactive platform. This procedure can help users to achieve resources allocation, decline the idle time of the platform and reduce waste of resources effectively.

3. Users sign online trading contracts and conduct online payment, and supply evaluation to the trading party after finishing the trading, wherein users deal with problems such as legal problems, taxation problems, etc. occurring in the trade by using the deal right protection module during or after the trade. Trading contracts include a labor contract, a contract of assignment of copyright, a contract of watching movie, a contract of the trade of film derivation, and a usage contract of advertisement position, etc.

4. Analysis application module can supply analysis and give out feasible programs according to the user requirement. This procedure creates supply service for the analysis and application of the whole network platform with big data.

5. Users can trace the progress and funds usage condition of the project through the project management module.

6. Users invest the feasible project supplied by the network interactive platform, and manage the investment project. At the same time, users can also finance project inside the network interactive platform, and manage financing project. Users can realize investment and financing and conduct management by using the network platform through this procedure.

7. Conducting development of derivatives. As film and television derivatives are one part of the industrial chain, users can make use of all of the functions of the platform to make a development thereto. While in the developing process of derivatives, users can use the investment and financing function of a network platform to realize and manage the investment and financing of the project of the film and television derivatives. Users can make use of business service function of the network platform to set up the derivatives related to the operation of business institutions. Users can make use of the resource allocation function of the network platform to realize the cooperative development of film and television derivatives, including design, production, advertising publicity, agency, authorization, and usage license, etc. Users can make use of the online trading function of the network platform to realize online trading such as cooperative development and sales with respect to the film derivations. Users can make use of the analysis and application function of the network platform to provide service for the field of the film and television derivatives. Users can make use of project management function of the network platform to learn about and manage the progressive conditions of the development project of the film derivations.

Above all, the following effects can be achieved through the case. Firstly, in film production, the optimized allocation of resources is conducted according to the requirements between film individuals and groups to promote the cooperation effectively. Secondly, the supported network trade services such as online trading, evaluation systems, follow-up services, etc. are established to help users to understand conditions such as the credibility, working ability for convenience to make decisions in advance and ask for legal remedy at the same time as ensuring the trade. Thirdly, the faults between decision-making consulting and application layers are reduced to meet the actual requirement of users. Fourthly, users can learn about and manage the project condition of film investment and financing in real time. Finally, the effective, convenient and classified development and sales channel are provided to the film and television derivatives.

Case III

The following services are supplied to different customers through the business service module.

The user A is located in Beijing, and its company needs to be set in Beijing. The business service module is used to deal with the establishment of the company, including matters for law and finance, etc.

The user B is located in Beijing, and its company needs to be set in British Virgin Islands. The business service module is used to complete the establishment of the company.

The user C operates a single business, and the business service module is used to supply operation format services, including law, finance and taxation, such as agent financial statements, enterprise annual reports, taxation payments, supplying trading contracts, format evidence security, legal consulting, and rights protection services, etc.

The user D operates diversified cross-border business, and the business service module is used to supply the operation personalized service.

The user E plans to make bankruptcy and go into liquidation. The business service module is used to conduct clearance according to the financial documents during the operation.

The user F decides to terminate business operation because of divorce, and partitions s the existing finances to be after-marriage wealth to conduct clearance and then divides up possessions proportionally. The business service module is used to supply the personalized services for terminating business operation.

The above-mentioned descriptions represent merely the exemplary embodiment of the present disclosure, without any intention to limit the scope of the present disclosure thereto. Various equivalent changes, alterations or modifications based on the claims of the present disclosure are all consequently viewed as being embraced by the scope of the present disclosure.

What is claimed is:

1. A network interactive platform, comprising: a resource configuration module, an analysis application module, a deal right protection module, a business service module, a project management module, an investment and financing module, a database module and a derivative module, wherein:
the resource configuration module is used in a mutual election among investor and producer, producer and cast, and relevant materials, and gives out allocation results and also used in the cooperative development of film and television derivatives;
the analysis application module is used to conduct data analysis and gives out application projects according to the results of the data analysis and user requirement;
the deal right protection module; if users ensure to conduct trading according to the allocation results and application programs, the deal right protection module gives out format contracts according to trading types, and saves trading data to database module automatically; if users supply a rights protection request, an evidence service is provided through the saved trading data, and a rights protection service is provided according to the result of the obtained evidence;
the business service module includes a setting up service module, an operation service module, a terminating business operation service module, a legal service module, a financial service module, and a taxation service module;
the project management module is used to provide project progressive conditions, such as project progress, funds expenditure, and a project management process includes the whole process of film and television preparation, production, issuing, and showing, and a combination thereof;
the investment and financing module is used to manage investment funds according to the progressive conditions of the project, and used to conduct project financing;
the database module is used to save users information, trading information, service information, project progressive information, etc.; and
the derivative module conducts cooperation and development of the film and television derivatives;
wherein users include individual user, group user and project user, individual users refer to users registered with the name of natural person, group users refer to users that are registered with the name of legal person or other organizations, and project users refer to users that are registered with the name of project.

2. The platform according to claim 1, wherein the trading data includes user information, user exchange information, information of trading forming time, and contracts.

3. The platform according to claim 2, the resource configuration module further including an exhibition module and a matching module, wherein the exhibition module is used to exhibit the user information, the user information includes static information and dynamic information, the matching module is used in investor and producer, and a mutual election between producer and cast, and a matching is conducted according to user requirement.

4. The platform according to claim 3, wherein the deal right protection module is used to supply customized contracts according to the requirement of both the parties of the trading.

5. The platform according to claim4, wherein a setting service module in the business service module is used to supply service for the behavior of users to set up company, enterprise and other organizations; the business service module is used to supply service for the business behavior of users; a terminating business operation service module is used to supply service to the behavior of users to terminate business; a legal service module is used to supply legal service for the behavior of a setting, operation and termination of users; a financial service module is used to supply financial service for the behavior of a setting, operation and termination of users; and a taxation service module is used to supply taxation service for the behavior of a setting, operation and termination of users.

6. The platform according to claim 5, wherein each module in the business service module includes a format service module and a personalized service module.

7. The platform according to claim 1, wherein the legal service module supplies legal service according to the trading data that is obtained from the database module.

8. A method adapted to a network interactive platform including the following steps of which a sequence is made according to actual requirements:
conducting a mutual election among investor and producer, producer and cast, and relevant materials, giving out allocation results, and implementing cooperative development of film and television derivatives;
conducting data analysis of film and television, and giving out application programs according to the result of the data analysis and user requirement;
if users ensure to conduct trading according to the allocation results and application programs, a deal right protection module giving out format contracts according to the trading type and saving trading data to the database module automatically; if users ask for a right protection request, an evidence service being provided through the saved trading data and a right protection service being provided according to a result of the obtained evidence service;
implementing operations such as an establishment of business service, an operation of business service, a terminating business operation service, a legal assistance service, and a financial service and taxation service;
conducting project tracing, suppling project progressive conditions automatically, such as a project progress and a capital expenditure;
conducting management to invested funds according to the project progressive conditions, and conducting project financing;
saving user information, trading information, service information and project progressive information through a database; and
conducting cooperation and development of films and televisions derivatives.
